(19) United States
(12) Patent Application Publication
(10) Pub. No.: US 2007/0052661 A1
(43) Pub. Date: Mar. 8, 2007

(54) Luminance control method and a display device using the same

(75) Inventor: Daisuke Shikata, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/510,641

(22) Filed: Aug. 28, 2006

(30) Foreign Application Priority Data
Sep. 2, 2005 (JP) 2005-254913

(51) Int. Cl. G09G 3/36

(52) U.S. Cl. 345/102

(57) ABSTRACT

A display device includes a light source, a light guide plate diffusing light issuing from the light source and a non-light-emitting display panel illuminated with light being emitted from the light source via the light guide. The display device includes a storage for storing correction values determined beforehand for making the luminance on the display panel substantially uniform. The display device also includes a corrector for reading out one of the correction values corresponding to a position where display data are displayed from the storage and for correcting the gain of the display data for thereby making the luminance on the display panel substantially uniform.

### BACKGROUND OF THE INVENTION

1. Field of the Invention

The present invention relates to a luminance control method and a display device, and more particularly to a luminance control method for correcting an irregular luminance distribution appearing on the display screen of a display panel of the type illuminated by a backlight mechanism and a display device using the same.

2. Description of the Background Art

A liquid crystal display (LCD) device for displaying data on an LCD screen or similar display device of the type using a non-light-emitting type of display panel includes a backlight mechanism configured to emit backlight toward the rear surface of the display panel. The backlight mechanism includes light emitting diodes (LEDs) or similar light sources and a light guide plate for diffusing light issuing from the light sources. some of the problems with the backlight mechanism are that the distance between the light sources and the light guide plate is not precisely uniform and that light issuing from the light sources has directivity. As a result, dark portions and a light portion exist in the backlight, resulting in an irregular luminance distribution.

The irregular luminance distribution of the backlight directly translates into an irregular luminance distribution on the display panel, which makes data visualized on the front surface or display screen opposite to the rear surface of the display panel hard to see.

In light of the above, a method and a device for reducing the irregular luminance distribution by controlling the backlight have been proposed in various forms in the past. Japanese patent laid-open publication No. 239659/1998, for example, discloses a control method that stores correction control values calculated beforehand, reads out one of the control values matching with a position where data are to be displayed, and controls the emission luminance of each light source itself, thereby making the luminance of the entire backlight uniform.

However, the control method taught in the above patent publication has a drawback that even if the emission luminance of each light source itself is controlled, it is difficult to control luminance in, e.g. only a particular portion of the display screen of a display panel because light issuing from the light sources is diffused by a light guide plate, making it difficult to accurately control luminance on the display screen of the display panel. Moreover, such a control method is apt to aggravate the power consumption of the display panel.

### SUMMARY OF THE INVENTION

It is an object of the present invention to provide a luminance control method and a display device capable of accurately establishing uniform luminance on the entire display screen of a display panel.

A display device of the present invention includes a light source and a backlight mechanism, including a light guide plate for diffusing light issuing from the light source, and establishes uniform luminance on a non-light-emitting display panel when display data are displayed on the display panel with the light being emitted from the light source toward the display panel via the light guide plate. The display device includes a storage which stores correction values determined beforehand for making the luminance on the display panel substantially uniform. The display device includes a corrector for reading out one of the correction values corresponding to a position where display data are displayed from the storage to correct the gain of the display data for thereby making the luminance on the display panel substantially uniform.

A luminance control method applicable to the above display device is also disclosed.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of an LCD device in accordance with the present invention;

FIG. 2A is a front view schematically showing an LCD panel and a backlight mechanism included in the illustrative embodiment shown in FIG. 1;

FIG. 2B is a side elevation showing the LCD panel and the backlight mechanism of the illustrative embodiment;

FIG. 3 is a flowchart useful for understanding a specific procedure executed by the illustrative embodiment for selecting a correction value;

FIG. 4 is a flowchart useful for understanding a specific correction procedure executed by a corrector included in the illustrative embodiment;

FIG. 5 is a front view, like FIG. 2, useful for understanding another specific method of storing correction values available with the illustrative embodiment;

FIG. 6 is a flowchart useful for understanding a specific procedure available with the illustrative embodiment for selecting a linear function;

FIG. 7 is a front view, like FIG. 2, useful for understanding a further specific method of storing correction values available with the illustrative embodiment; and

FIG. 8 is a flowchart useful for understanding another specific procedure executed by the corrector of the illustrative embodiment.

### DESCRIPTION OF THE PREFERRED EMBODIMENT

Briefly, considering the fact that a uniform luminance distribution can be established on the display screen of a display panel not by controlling a backlight mechanism, but by controlling data to be displayed, a luminance control method and a display device in accordance with the present invention control the gain of display data in matching relation to a difference in luminance on the display panel.

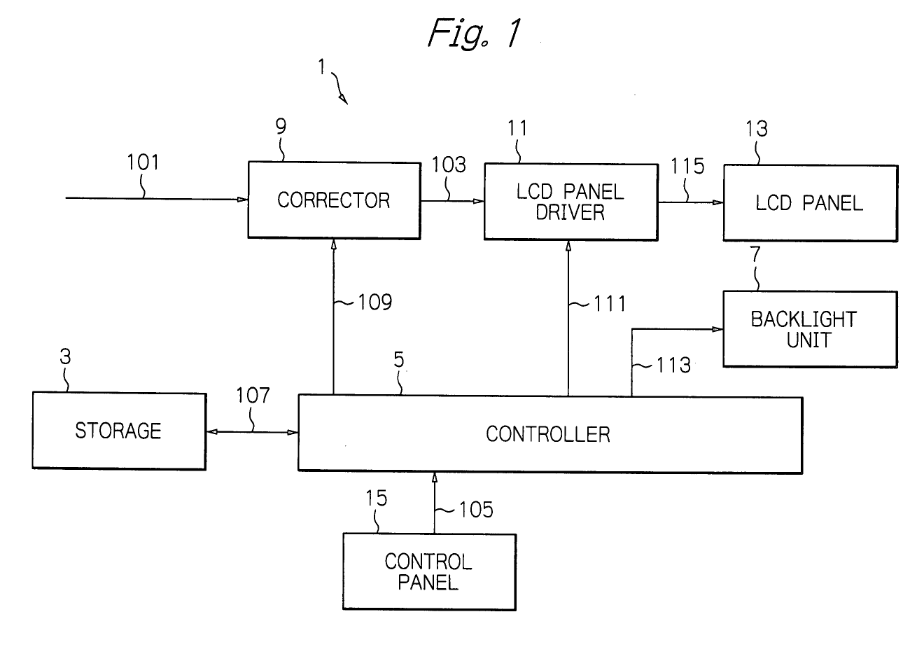

Referring to FIG. 1 of the accompanying drawings, a display device embodying the present invention is implemented as a liquid crystal display (LCD) device by way of example. As shown, the LCD device, generally 1, includes a storage 3, a controller 5, a backlight unit 7, a corrector 9, a LCD panel driver 11, an LCD panel 13 and a control panel 15 which are interconnected as illustrated to be configured to display display data 101 input thereto on the display screen of the LCD panel 13. The display data 101 may be representative of either one of a movie or a still image, and may even include text data. In the figures, elements not directly relevant to the understanding of the present invention are not shown, and detailed description thereof will not be made in order to avoid redundancy.

In the illustrative embodiment, the controller 5 is a general controller adapted to control the operation of the entire LCD device 1 in response to, e.g. an operation signal 105 received from the control panel 15, and includes a CPU (Central Processing Unit) by way of example. Signals are designated with reference numerals designating connections on which they are conveyed. In the illustrative embodiment, the controller 5 generates control signals 107, 109, 111 and 113 in response to, e.g. the operation signal 105, and feeds them to the storage 3, the corrector 9, an LCD panel driver 11, the LCD panel 13 and the backlight unit 7 respectively. The storage 3 is capable of storing correction values fed from, e.g. the control panel 15. Of course, the storage 3 may be adapted to store another signals or values.

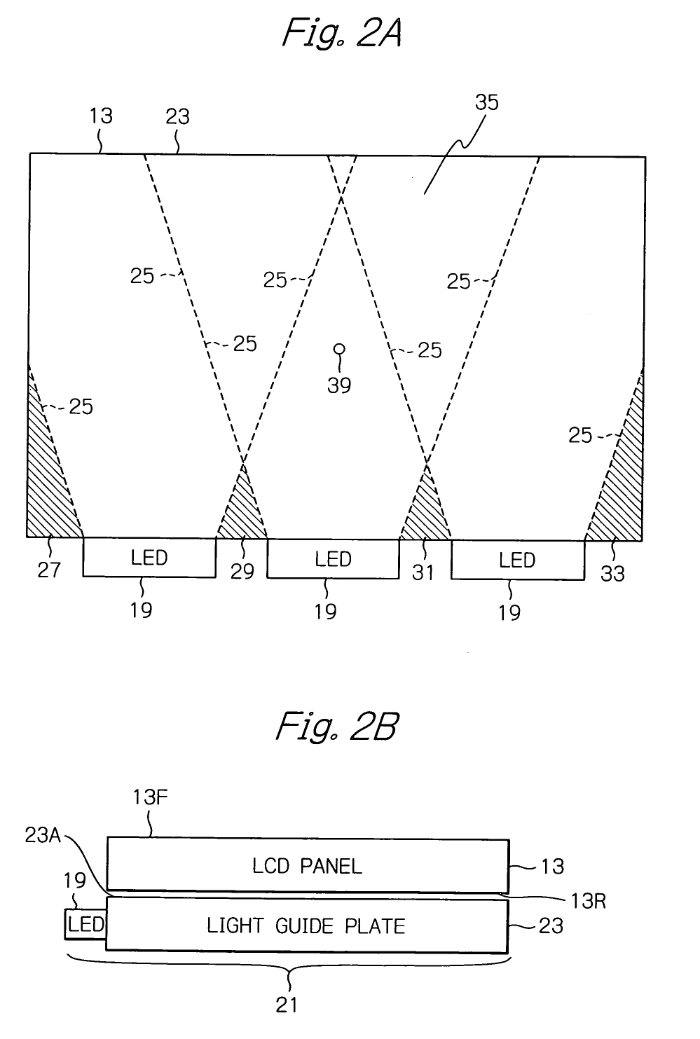

The LCD panel driver 11 is adapted to execute processing under the control of the controller 5 to serve as driving the LCD panel 13. The LCD panel 13 is arranged to display the display data 101 on the LCD panel in response to, e.g. the control signal 115 received from the LCD panel driver 11. The backlight unit 7 includes a backlight mechanism and executes processing under the control of the controller 5 to provide the backlight toward the rear surface 13R, FIG. 2A, opposite to the front surface or viewing screen 13F, of the LCD panel 13. The control panel 15 is a manual input device on which the operator of the apparatus may manually input desired information and commends. More specifically, the control panel 15 is designed to allow the operator to input a desired command thereon, and send a corresponding operation signal 105 to the controller 5.

Reference will be made to FIG. 2A for describing a specific irregular luminance on the display screen of the LCD panel 13 when the display data 101 are not displayed. FIG. 2A is a front view schematically showing the LCD panel 13 and the backlight mechanism 21, while FIG. 2B is a side elevation of the LCD panel 13 and the backlight mechanism 21. As shown in FIG. 2B, the LCD panel 13, which does not emit light itself, is illuminated by the backlight mechanism 21 from the back 13R. The backlight mechanism 21 is positioned at the back of the LCD panel 13 such that one of the primary surfaces 23A of a light guide plate 23 included in the mechanism 21 and the rear surface 13R of the LCD panel 13 are parallel to each other.

As shown in FIG. 2A, in the illustrative embodiment, light sources 19 are implemented as three light emitting diodes (LEDs) 19 located at substantially the same intervals below the light guide plate 23 as viewed in FIG. 2A. Each LED or light source 19 emits light toward the LCD panel 13 at least one side, e.g. bottom, of the LCD panel 13, as viewed in FIG. 2A, via the light guide plate 23. The light guide plate 23 diffuses the light issuing from the LEDs 19 so as to guide the diffused light toward the LCD panel 13.

Of course, the configuration of the backlight mechanism 21 shown in FIGS. 2A and 2B is only illustrative and may be changed or modified, as desired. Also, the light sources 19 may be constituted by any suitable type of light sources other than LEDs and may be implemented by any desired number of LEDs 19 matching with the configuration of the backlight mechanism 21. LEDs are advantageous in that light emitted therefrom has directivity and therefore allows part of the LCD panel 13 different in luminance from the other part to be easily detected.

As shown in FIG. 2A, when the LEDs 19, having directivity each, illuminate the LCD panel 13 at one side 13R of the panel 13 via the light guide plate 23 as in the illustrative embodiment, they emit light to respective zones delimited by dotted lines 25. As a result, dark portions 27, 29, 31 and 33 indicated by hatching in FIG. 2A and a light portion 35 other than the dark portions 27 through 33 are formed on the display screen of the LCD panel 13, i.e. luminance on the display screen of the LCD 13 is not uniform. Display data 101, visualized on the display screen of the LCD panel 13 in such a condition, are hard to see.

In light of the above, as shown in FIG. 1, the illustrative embodiment is provided with the corrector 9 which is adapted to correct the gain of the display data 101 to deliver the corrected display data 103 to the LCD panel 13, thereby displaying the data 101 on the display screen of the LCD panel 13 as if uniform luminance of the backlight were established on the display screen. Particularly, with the illustrative embodiment, correction values are selected beforehand such that they are expected to make the luminance of the dark portions 27 through 33 substantially identical with the luminance of the light portion 35, and the gain of the display data 101 is corrected with adequate one of the correction values.

This successfully makes the corrected display data 101 viewed as if luminance on the entire display screen of the display panel 13 were substantially uniform in such a fashion that portion of the display data 101 which is displayed in the dark portions 27 through 33 is viewed uniform in brightness with the remaining portion of the data 101 which is not corrected. Specifically, the portion of the display data 101 which is to be displayed in the darker potions 27 through 33 is corrected with such an appropriate correction value as to attain the higher gain than that of the remaining portion of the display data 101 to be displayed in the brighter portion 35.

More specifically, the corrector 9, preceding the LCD panel driver 11, corrects the gain of the display data 101 to appear on the dark portions 27 through 33 and outputs the display data 103 thus corrected under the control of the controller 5. Of course, the corrector 9 may additionally or alternatively be adapted to correct the gain of the display data 101 to appear on the light portion 35. For the correction, the corrector 9 uses correction values stored in the storage 3 and determined beforehand to make luminance on the LCD panel 13 substantially uniform. In the illustrative embodiment, the correction values are selected to values necessary for making the luminance of the dark portions 27 through 33 substantially the same as the luminance of the light portion 35.

The illustrative embodiment uses the correction values mentioned above because it is configured to make the luminance of the dark portions 29 through 33 substantially identical with the luminance of the light portion 35 so as to establish uniform luminance over the entire LCD panel 13 by. Alternatively, there may be used any other correction values in accordance with how luminance on the LCD panel 13 should be uniformed. For example, if luminance in the light portion 35 should be substantially matched to luminance in the dark portions 27 through 33 when the display data are displayed in the light portion 35, a correction value that makes the luminance of the light portion 35 substantially identical with the luminance of the dark portions 27 through 33 is selected. Alternatively, if luminance should be matched to a reference level over all positions where the display data 101 are to be displayed to render the luminance uniform over the entire display screen of the LCD panel 13, a correction value is selected which establishes the reference luminance level over the entire LCD panel 13.

The correction values maybe determined by calculation, measurement or similar method beforehand. For example, the correction values may be produced by calculation on the basis of a difference in luminance on the display screen of the LCD panel 13 that can be estimated from the configuration of the backlight mechanism 21, by actually measuring the luminance of the dark portions 27 through 33 and the luminance of the light portion 35 or by measuring the luminance of the LEDs or light sources 19.

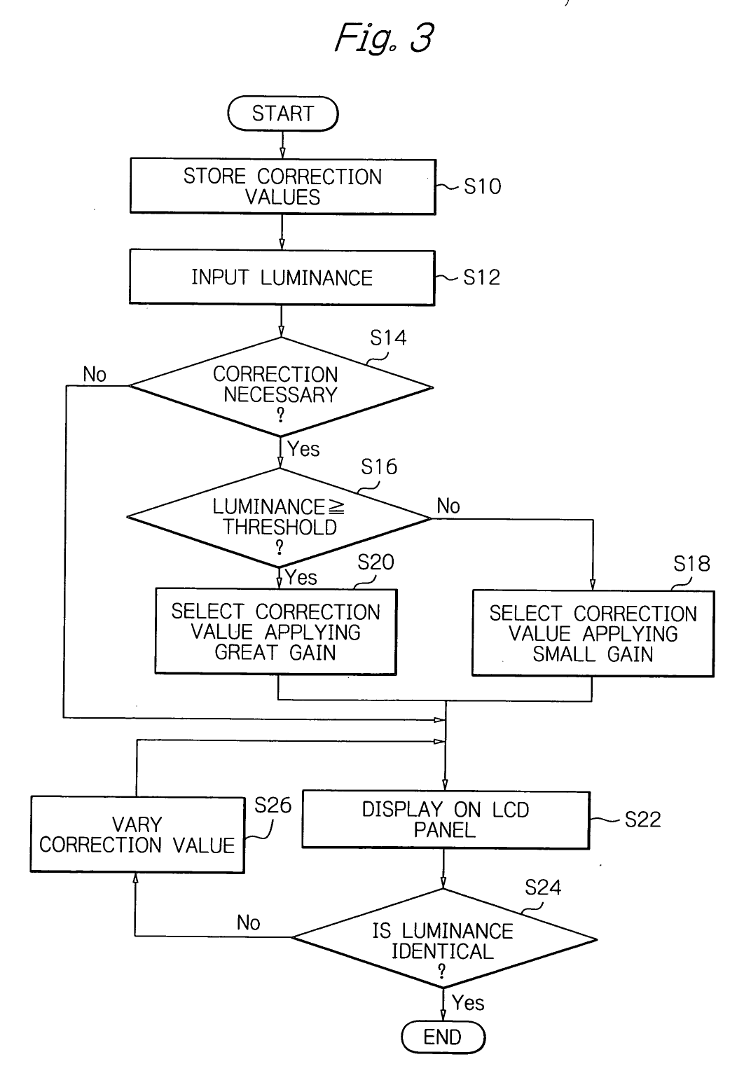

FIG. 3 is a flowchart demonstrating a specific procedure available with the illustrative embodiment for selecting an adequate correction value. Briefly, the procedure of FIG. 3 determines correction values by calculation beforehand, causes luminance on the display screen of the LCD panel 13 to be measured by, e.g. a conventional luminance meter, and then executes correction to obtain a correction value matching with the LCD panel 13 for thereby selecting adequate correction values.

Why a correction value is selected after the measurement of luminance on the display screen of the LCD 13, as stated above, is that the lightness of the LEDs or light sources 19 included in the backlight mechanism 21 is not always the same. For example, when the LEDs 19 included in the backlight mechanism 21 is relatively dark, the difference between the light portion 35 and the dark portions 27 through 33 is great, so that the gain of the display data 101 to appear in the dark portions 27 through 33 must be increased. In such a case, a correction value for applying a great or higher gain to the display data 101 is selected. Conversely, when the LEDs 19 included in the backlight mechanism 21 is relatively light, a correction value for applying a small or lower gain to the display data 101 is selected because the difference between the dark portions 27 through 33 and the light portion 35 is small.

As shown in FIG. 3, correction values are calculated beforehand and stored in the storage 3 (step S10). The correction values are standard correction ones calculated from the mean lightness of the light sources 19, FIG. 2, for each display position of the LCD panel 13. Alternatively, the correction values may be determined for, e.g. each of the dark portions 27 through 33. Subsequently, luminance is measured by, e.g. a conventional luminance meter at substantially the center 39, see FIG. 2, of the display screen of the LCD panel 13.

Why luminance at the center 39 is measured, as stated above, is that if the lightness of the light sources 19 is different from standard lightness, luminance at the center 39 is different from the standard luminance, showing that the lightness of the light sources 19 is different from the standard lightness. In this respect, the above measurement allows a difference between the individual light sources 19 to be determined more easily than when the lightness of the individual light sources is measured. Of course, luminance may be measured at any position other than the center 39 of the display screen. Also, the luminance of the individual light sources 19 may be measured one by one, if desired. The luminance measured at the center 39 is input to the LCD device 1 (step S12).

Subsequently, the controller 5 or operator determines whether or not the measured luminance is the standard luminance, i.e. whether or not the correction values should be varied (step S14). If the luminance is the same as the standard luminance (No, step S14), the controller 5 uses the correction values stored in the storage 3 without correcting them. On the other hand, if the luminance is different from the standard luminance (Yes, step S14), the controller 5 determines whether or not the measured luminance is higher than a preselected threshold value inclusive (step S16).

If the measured luminance is lower than the threshold value (No, step S16), meaning that the difference in luminance between the dark portions 27 through 33 and the light portion 35 is small, the controller 5 or operator varies the correction values read out from the storage 3 toward values that apply a small gain (step S18). Conversely, if the measured luminance is higher than the threshold value (Yes, step S16), meaning that the difference in luminance between the dark portions 27 through 33 and the light portion 35 is great, the controller 5 or operator varies the correction values read out from the storage 3 toward values that apply a great gain (step S20). The controller 5 or operator, thus having corrected the correction values, corrects the gain of the display data 101 of the test sample with such correction values and then displays the corrected display data on the LCD panel 13 (step S22).

Subsequently, the operator, for example, determines whether or not the luminance is substantially identical between the dark portion 27 through 33 and the light portion 35 (step S24). If the luminance is not identical (No, step S24), the controller 5 or the operator varies the correction values toward adequate values for the light sources 19 (step S26). Conversely, if the luminance is substantially identical (Yes, step S24), the procedure proceeds to its end as shown in FIG. 3.

As stated above, by measuring the luminance of the display screen of the LCD panel 13 and then determining correction values, it is possible to determine correction values matching with the lightness of the individual light sources 19. Also, correction values can be determined when, e.g. on a manufacturing line of the device 1, the display screen of the individual LCD panels 13 is measured with a luminance meter and lightness is adjusted, so that it is not necessary to measure the display screens of the LCD panels 13 in an extra step. Consequently, correction values can be determined in accordance with differences in lightness between the individual light sources 19 without increasing manufacturing cost. Of course, the procedure of FIG. 3 is only illustrative and may be changed or modified, as desired.

The correction values determined by the above procedure position by position are written to the storage 3 in the form of correction table. While the illustrative embodiment prepares the correction table in order to indicate correspondence between the display positions and the correction values, the correction values may be stored by any other suitable method. As shown in FIG. 2, in the illustrative embodiment, the dark portions 27 and 33 are identical in shape and substantially identical in luminance and geometrically symmetrical to each other in a plane containing the LCD panel 13. This is also true with the dark portions 29 and 31. It therefore suffices to list in the correction table only the correction value of one of the dark portions 27 and 33 in pair and the correction value of one of the dark portions 29 and 31 also in pair, thereby reducing the amount of information to be stored in the storage 3 and hence a load on the storage 3. Of course, the correction values of all the dark portions 27 through 33 maybe listed in the correction table, if desired.

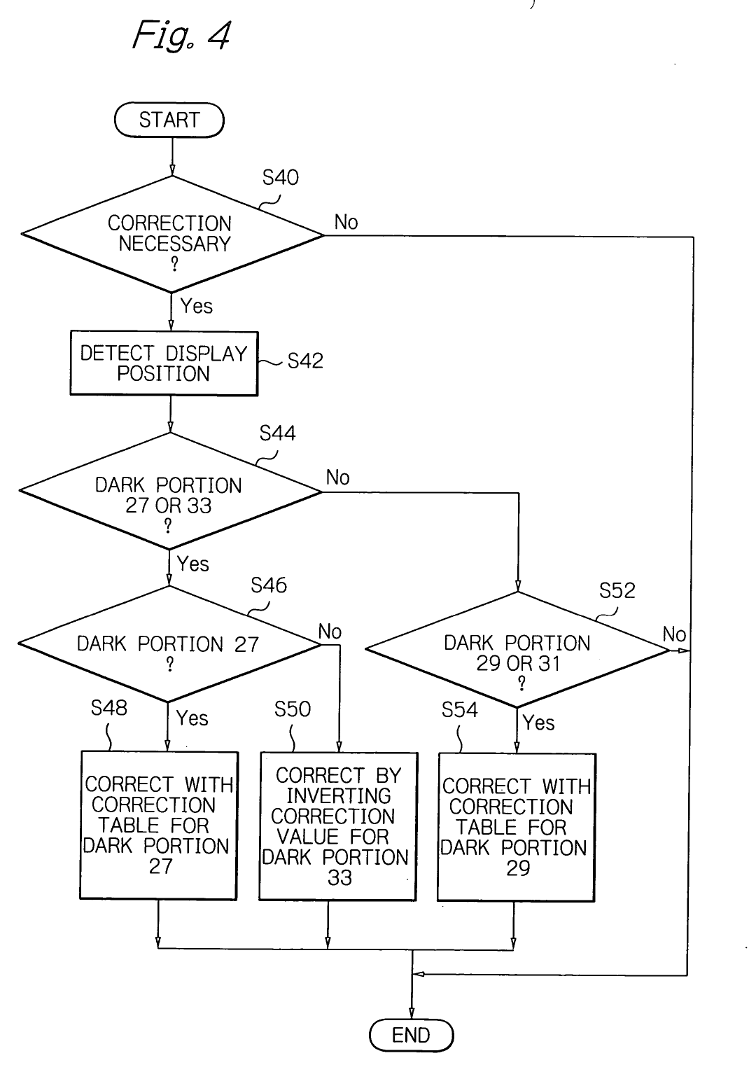

FIG. 4 is a flowchart showing a specific gain correction procedure by the corrector 9 for adjusting the gain of the display data 101 with the correction table, not shown. In the procedure of FIG. 4, the corrector 9 executes correction by referencing a correction table relating to the dark portion 27 and a correction table relating to the dark potion 29. As shown, upon receiving the display data 101, the corrector 9 determines whether or not to execute correction with the display data 101 (step S40). If the display data 101 do not need correction (No, step S40), then the corrector 9 ends the procedure of FIG. 4 and simply delivers the display data 103 to the LCD panel driver 11 without correcting their gain.

On the other hand, if the display data 101 need correction (Yes, step S40), the corrector 9 detects a display position where the display data 101 should be displayed (step S42) and then determines whether the display position lies in the one dark portion 27 or in the other dark portion 33 (step S44). If the display position lies in the one dark portion 27 (Yes, step S46), the corrector 9 reads out the correction table relating to the dark portion 27 from the storage 3 and then corrects the gain of the display data 101 with a correction value listed in the correction table (step S48), and ends the correction procedure. Conversely, if the display position lies in the other dark portion 33 (No, step S46), the corrector 9 reads out the correction table relating to the one dark portion 27 from the storage 3 and then inverts the correction table to thereby obtain a correction value. Subsequently, the corrector 9 corrects the gain of the display data 101 with the above correction value (step S50) and ends the correction procedure.

If the display position lies in neither one of the dark portions 27 and 33 (No, step S44), then the corrector 9 determines whether or not the display position lies in the dark portion 29 or 31 (step S52). If the display position lies in neither one of the dark portions 29 and 31 (No, step S52), then the corrector 9 determines that the display position lies in the light portion 35 and ends the correction procedure by simply delivering the display data 103 to the LCD panel driver 11. Conversely, if the display position lies in the dark portion 29 or 31 (Yes, step S52), then the corrector 9 reads out the correction table relating to the dark portion 29, corrects the gain of the display data 101 with a correction value listed in the table (step S54), and then ends the correction procedure. It should be noted the inversion of the correction table is not necessary when the display position belongs to the dark portion 29 or 31.

The display data 103 thus corrected by corrector 9 are fed to the LCD panel 13 via the LCD panel driver 11. Because the gain of the display data lying in any one of the dark portions 27 through 33 are corrected, as stated above, substantially the same luminance is established over the entire display screen of the LCD panel 13. Further, the gain is corrected in accordance with the display position of the output data 103, so that luminance in, e.g. only a particular portion of the display screen of the LCD panel 13 can be accurately controlled. Moreover, the backlight mechanism 21 does not have to be controlled and therefore consumes the minimum of power.

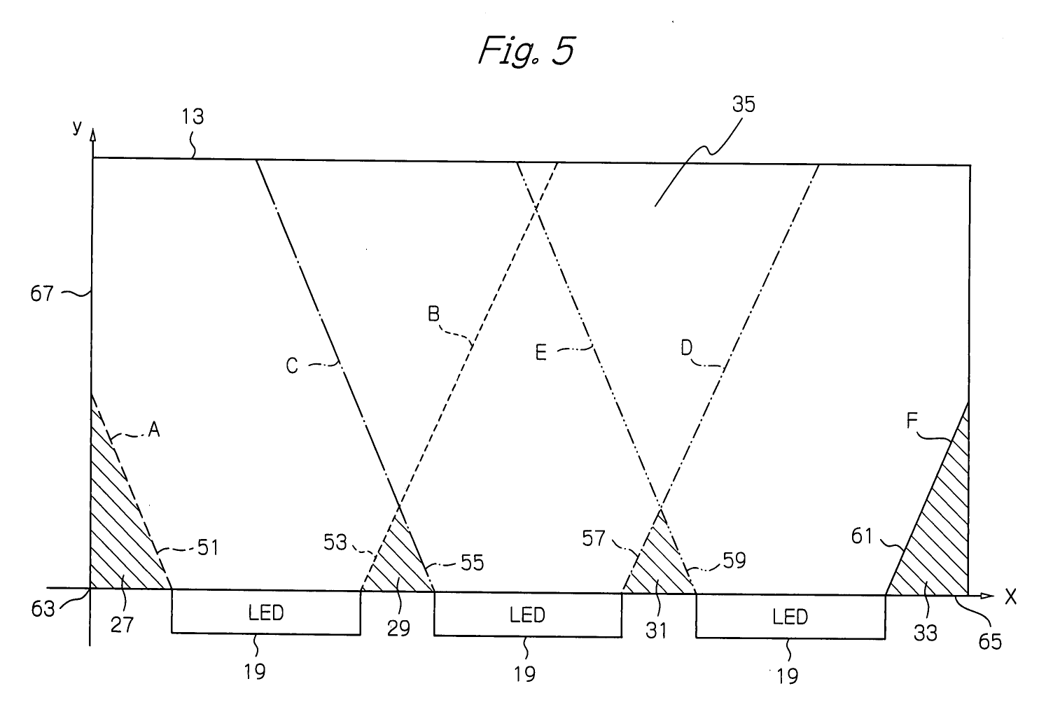

Reference will be made to FIG. 5 for describing another specific method of storing correction values in the storage 3. In FIG. 5, structural parts and elements like those shown in FIG. 2 are designated by identical reference numerals, and will not be described specifically in order to avoid redundancy. As shown, a particular correction value is assigned to each of the dark portions 27 through 33 while each dark portion with the correction value is defined by a particular mathematical function.

More specifically, the dark portions 27 through 33 and light portion 35 are delimited by boundaries 51, 53, 55, 57, 59 and 61 dividing them from each other, which are substantially straight because the LEDs 19 have directivity. It is therefore possible to approximate each of the boundaries 53 through 61 by a particular linear function and therefore to designate each of the dark portions 27 through 33 by a particular approximated linear function. Data defining such linear functions and correction values assigned to the dark portions 27 through 33 defined by the linear functions are stored in the storage 3. This further reduces the amount of information stored in the storage 3 and therefore a load on the storage 3, compared to the procedure of FIG. 3 in which the correction table is stored.

The functions mentioned above may be determined by, e.g. calculation or measurement. Also, the correction values assigned to the dark portions 27 through 33 defined by the functions may be determined by any suitable method, e.g. the method included in the procedure of FIG. 3 or by calculation based on the characteristic of the light sources 19. The linear functions are, of course, only illustrative and may be approximated by suitable functions matching with the boundaries 51 through 61. Further, the correction values stored in the form of table or functions are not limitative, but only illustrative.

The method seen from FIG. 5 will be described in detail hereinafter. As shown, the boundaries 51 through 61, delimiting the dark portions 27 through 33, are substantially straight because of the directivity of light issuing from the light sources 19. Therefore, assuming planar coordinates having its origin 63 which is the left end of a bottom side 65 in the figure where the LEDs 19 emit light and axes X and Y which are the bottom side 65 and a left side 67, respectively, the boundaries 53 through 61 between the light portion 35 and the dark portions 27 through 33 are approximated by linear functions A, B, C, D, E and F. The boundary 51, for example, between the dark portion 27 and the light portion 35 may be approximated by the linear function A expressed as:
y=−ax+b
where a and b are positive numerical values. The dark portion 27 is therefore defined by a portion positioned on the linear function A and a portion positioned at the left-hand side of the same as viewed in FIG. 5.

While the linear function A is determined such that the points on the linear function A are also included in the dark portion 27, whether or not to include the points on the function A in the dark portion is open to choice and may be determined in accordance with the kind of a function to be selected.

The other boundaries 53, 55, 57, 59 and 61 can also be approximated by the linear functions B, C, D, E and F, respectively. The linear functions C and E, like the linear function A, are a function having its negative slope and its positive intercept each while the linear functions B, D and F are a function having its positive slope and its negative intercept each. The dark portion 29 is delimited by a portion positioned on the linear function B, a portion positioned at the right-hand side of the linear function B and the left-hand side of the linear function C and a portion positioned on the linear function C as viewed in FIG. 5. Likewise, the dark portion 31 is delimited by a portion positioned on the linear function D, a portion positioned at the right-hand side of the linear function D and the left-hand side of the linear function E and a portion positioned on the linear function E. Also, the dark portion 33 is delimited by a portion positioned on the linear function F and a portion positioned at the right-hand side of the linear function F.

When the dark portions 27 through 33 are represented by the functions, as stated above, correction values are not determined on a display position basis, but are determined on a dark portion basis. It follows that correction values, applying great gains, are apt to render the boundaries 51 through 61 conspicuous. In this sense, the correction values should preferably be, but not limited to, correction values that apply small gains.

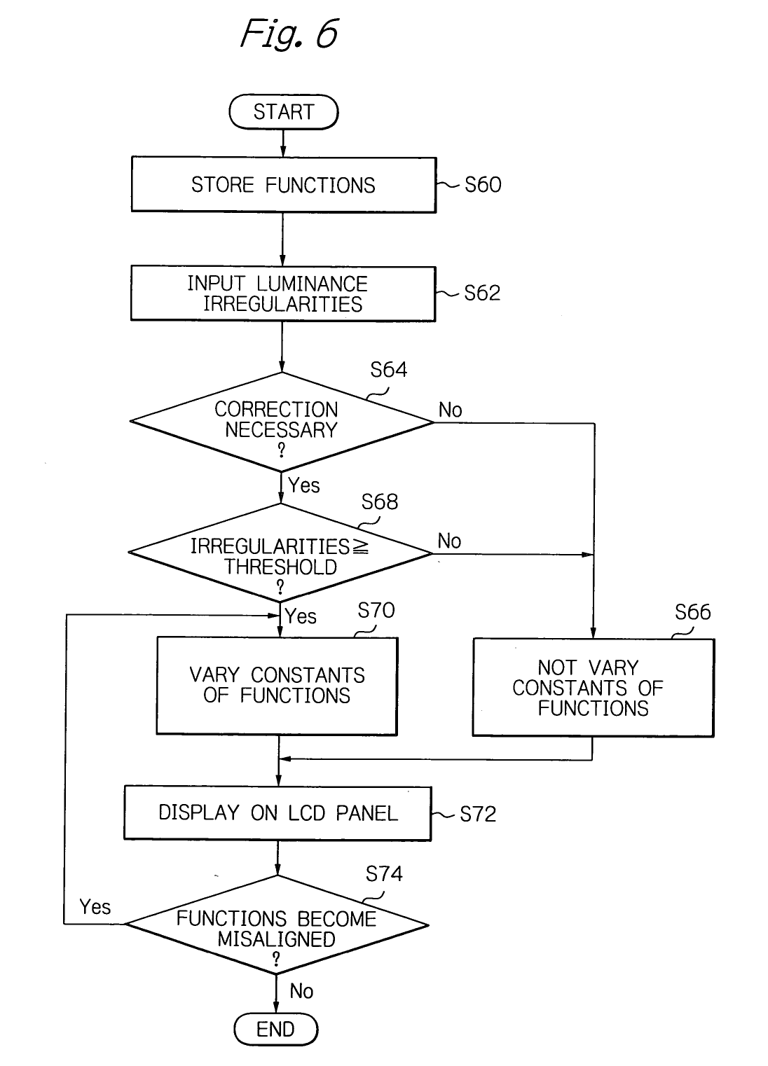

FIG. 6 is a flowchart of a specific procedure for determining the linear functions that approximate the boundaries 51 through 61. Briefly, the procedure of FIG. 6 determines linear functions on the boundaries 51 through 61 beforehand, measures irregularities in luminance on the display screen of the LCD panel 13, varies, if not determining that the boundaries 51 through 61 could be approximated, the constants of the linear functions to thereby produce new linear functions, and then use the new linear functions as linear functions for approximation.

To measure the irregularities in luminance, there is used a conventional luminance irregularity meter configured to measure nine points, for example, positioned at equal intervals on the display screen of the LCD panel 13 or to measure the entire display screen of the LCD panel 13. Further, the measurement is effected via a white or a semitransparent filter because such a filter makes irregularities in luminance easily visible.

By determining functions after the measurement of irregularities in luminance, as stated above, it is possible to decide, even when the light sources 19 included in the backlight mechanism 21 are different in directivity from each other, the functions matching with the individual light sources 19, thereby making luminance uniformly viewed on the display panel of the LCD panel 13 with higher accuracy.

More specifically, as understood from FIG. 6, linear functions for the boundaries 51 through 61 are determined by calculation or measurement beforehand and data defining the linear functions are written to the storage 3 (step S60). Subsequently, irregularities in luminance are measured and input to the LCD device 1 with, e.g. the manual input device (step S62). In response, the controller 5 or operator determines whether or not the light sources 19 are different in directivity from each other, and then determines whether or not to correct the liner functions determined beforehand (step S64). If correction is not necessary (No, step S64), the controller 5 uses the linear functions stored in the storage 3 without correcting them (step S66).

On the other hand, if correction is necessary (Yes, step S64), then the controller 5 determines whether or not the irregularities are greater than the predetermined threshold value (step S68). If the irregularities are greater than the threshold value (Yes, step S68), then the controller 5 or operator varies the constants of the individual linear functions stored in the storage 3, i.e. varies the slopes or effects parallel shift for thereby producing new linear functions matching with the irregularities in the luminance of the LCD panel 13 (step S70). Conversely, if the irregularities are smaller than the threshold value (No, step S68), the controller 5 uses the stored linear functions without any correction (step S66).

The controller 5 then makes the corrector 9 correct the gain of the display data 101 of the test sample with the correction value delimited by the determined linear function to display the corrected display data 101 on the LCD panel 13 (Step S72). Subsequently, the operator, for example, determines whether or not the liner functions become non-misaligned (Step S74). If the liner functions become misaligned (Yes, step S74), the controller 5 or the operator varies the constants of the individual liner again (step S70). Conversely, if the liner functions do not become misaligned (No, step S74), then the procedure ends as shown in FIG. 6. By the above procedure, linear functions that approximate the boundaries 51 through 61 are determined.

As stated above, the procedure of FIG. 6 determines functions by measuring irregularities in luminance on the LCD panel 13 for thereby accurately matching the functions to the directivities of the light sources 19 different from each other. Further, the functions can be determined when, e.g. the individual LCD panels 13 are measured by a luminance irregularity meter on a manufacturing line and adjusted, so that an extra step of measuring the LCD panels 13 one by one for determining functions matching therewith is not necessary. It is to be noted that functions can be determined by any suitable method other than the method shown in and described with reference to FIG. 6.

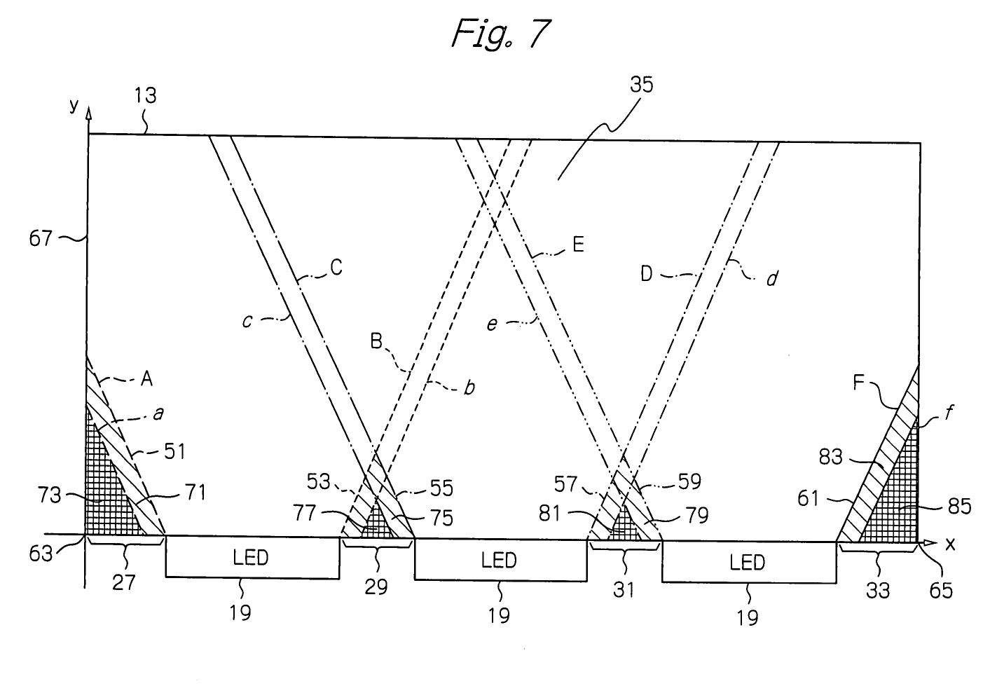

Another specific procedure for storing correction values in the storage 3 will be described with reference to FIG. 7. In FIG. 7 also, structural parts and elements like those of FIG. 5 are designated by identical reference numerals and will not be described specifically in order to avoid redundancy. Briefly, the procedure of FIG. 7 assigns two different linear functions to each of the boundaries 51 through 61 for thereby assigning different correction values to each of the dark portions 27 through 33. This successfully renders the boundaries 51 through 61 inconspicuous and therefore smooth display around the boundaries 51 through 61 on the display screen of the LCD display 13 when corrected display data 101 are displayed on the display screen. While the specific procedure of FIG. 7 assigns two linear functions to each boundary, any suitable number of boundaries may be assigned to each boundary; the greater the number of functions, the smoother display around the boundary.

For example, in the specific case shown in FIG. 7, a first and a second linear function A and a, respectively, are assigned to, e.g. the boundary 51 dividing the dark portion 27 from the light portion 35. The first linear function A is identical with the first function A of FIG. 5 and approximated to the boundary 51. The second linear function a is identical with the first linear function A except that the intercept is changed and that the function a is shifted from the function A inward of the dark portion 27, i.e. toward the Y axis 67. It is therefore possible to subdivide the single dark portion 27 into a first and a second dark portion 71 and 73, respectively, and assign a particular correction value to each of the two dark portions 71 and 73.

More specifically, the first dark portion 71, forming part of the dark portion 27, is made up of a portion positioned on the linear function A and a portion positioned at the left-hand side of the linear function a, as indicated by hatching in FIG. 7. A first correction value for applying a small gain is assigned to the first dark portion 7l. The second dark portion 7l, forming the other part of the dark portion 27, is made up of a portion positioned on the linear function a and a portion positioned at the left-hand side of the linear function a, as represented by grillage in FIG. 7. A second correction value for applying a gain greater than the first gain is assigned to the second dark portion 71. Why such correction values are assigned to the first and second dark portions 71 and 73 is that the second dark portion 73 is remoter from the light portion 35 than the first dark portion 71 and therefore darker than the first dark portion 73.

The first and second correction values assigned to the dark portion 27 make the boundary 51 inconspicuous for thereby smoothing display around the boundary 51. In addition, because the small gain and great gain are respectively applied to display data to appear on the first dark portion 71 and display data to appear on the second dark portion 73, it is possible to attain substantially the same effect as the correction using correction values stored in the storage 3 on a display position basis without increasing the amount of information stored in the storage 3 small.

As for the dark portion 33 symmetrical to the dark portion 27, a third portion 83 and a fourth portion 85, which are the reversal of the first and second dark portions 71 and 73, respectively, can be defined by the linear function F identical with the function F of FIG. 5 and a linear function f identical with the function F except for the shift of an intercept. The first and second correction values are assigned to the third and fourth dark portions 83 and 85, respectively, so as to make the boundary 83 inconspicuous for thereby smoothing display around the boundary 83.

In the dark portion 29, the linear function B identical with the function B of FIG. 5 and a linear function b identical with the function B except for the parallel shift of the intercept from the function B inward of the dark portion 29 are located at the left-hand side while the linear function C identical with the function C of FIG. 5 and a linear function c identical with the function C except for the parallel shift of the intercept from the function C inward of the dark portion 29 are located at the right-hand side as viewed in FIG. 7. In this condition, the linear functions B, b, C and c divide the dark portion 29 into a fifth dark portion 75 and a sixth dark portion 77.

The fifth dark portion 75 is delimited by a portion positioned on the linear function B, a portion positioned at the right-hand side of the function B, but at the left-hand side of the linear function b, and a portion positioned on the linear function C and a portion positioned at the left-hand side of the function C, but at the right-hand side of the linear function c, as indicated by hatching in FIG. 7. A third correction value for applying a small gain is assigned to the fifth dark portion 75. Likewise, the sixth dark portion 77 is delimited by a portion positioned on the linear function b, a portion positioned at the right-hand side of the function b, at the left-hand side of the function c and a portion positioned on the function c, as indicated by grillage in FIG. 7. A fourth correction value for applying a gain greater than the third correction value is assigned to the sixth dark portion 77. This is also successful to render the boundaries 53 and 55 inconspicuous for thereby smoothing display around the boundaries 53 and 55.

The dark portion 31 substantively identical to the dark portion 29 is also divided into a seventh dark portion 79 and an eighth dark portion 81 substantially identical in configuration with the sixth dark portion 77 by the linear function D, a linear function d, the linear function E and a linear function e. The third and fourth correction values are assigned to the seventh and eighth dark portions 79 and 81, respectively, also rendering the boundaries 57 and 59 inconspicuous and therefore smoothing display around the boundaries 57 and 59.

It may occur that the dark portions 29 and 31 are darker than the dark portions 27 and 33. In light of this, the third correction value applies a greater gain than the first correction value while the fourth correction value applies a greater gain than the second correction value. Eventually, the gains of the first to fourth correction values sequentially increase in this order.

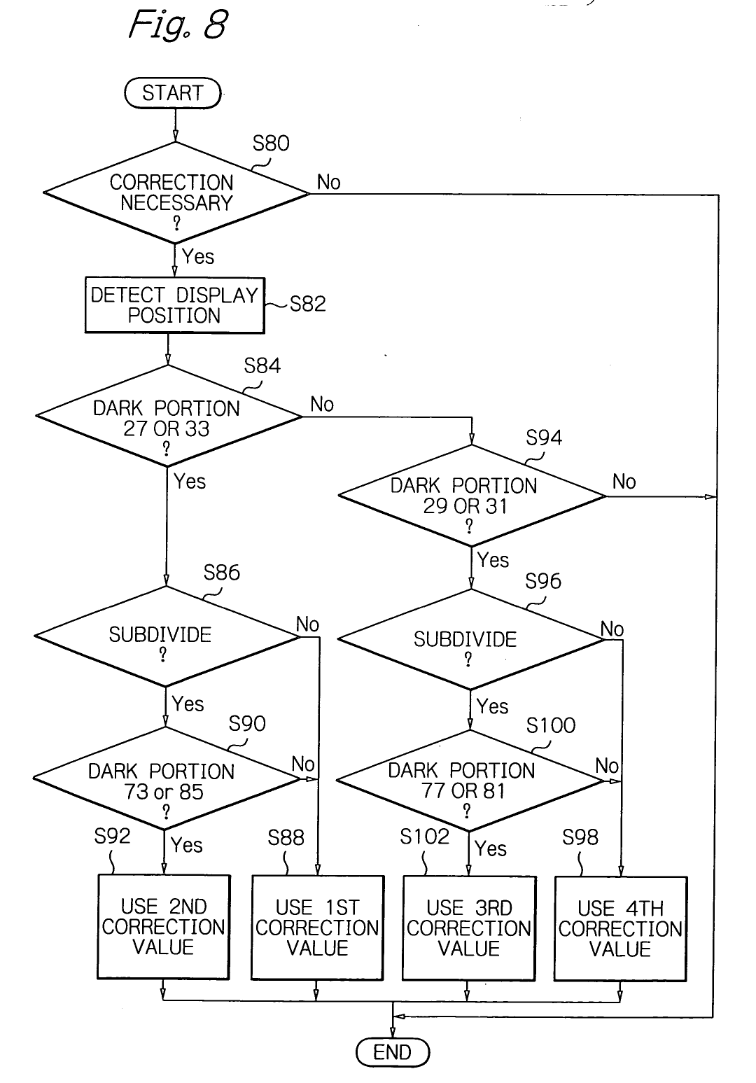

FIG. 8 shows another specific correction procedure available with the corrector 9 adapted to define the dark portions 27 through 33 with functions, and execute correction by using correction values respectively assigned thereto, as described with reference to FIG. 5, 6 or 7. The procedure of FIG. 8 is characterized in that it selectively executes correction without subdividing each of the dark portions 27 through 33, as shown in FIG. 5, or subdividing it, as shown in FIG. 7, i.e. either one of the storing methods shown in FIGS. 5 and 7. Stated another way, whereas the procedure of FIG. 5 or 7 stores the correction values assigned to the dark portions 27 through 33 or the dark portions 27 through 33 and subdivided dark portions 71 through 85, respectively, the procedure of FIG. 8 assigns the same correction value to each of the dark portions 27 through 33 or the subdivided portions of each of the dark portions 71, 75, 79 and 83 indicated by hatching in FIGS. 5 and 7 for thereby reducing the amount of information to be stored in the storage 3.

In the correction procedure of FIG. 8, therefore, the storage 3 stores the first correction value assigned to the dark portions 27, 33, 71 and 83, the second correction value assigned to the dark portions 73 and 85, the third correction value assigned to the dark portions 29, 31, 75 and 79 and the fourth correction value assigned to the dark portions 77 and 81. If desired, the same correction value may be assigned to the portions indicated by hatching in FIG. 5 or 7.

As understood from FIG. 8, the corrector 9 determines whether or not to correct the input display data 101 (step S80) If the display data 101 do not need correction (No, step S80), the corrector 9 ends the procedure of FIG. 8 and simply feeds the display data 103 to the LCD panel driver 11. If the display data 101 need correction (Yes, step S80), the corrector 9 detects a display position where the display data 101 should be displayed (step S82), and determines whether or not the display position is either one of the dark portions 27 and 33 (step S84).

If the display position is the dark portion 27 or 33 (Yes, step S84), then the corrector 9 determines whether or not to correct the dark portion 27 or 33 by subdividing it, i.e. whether the same correction should be applied to the dark portions 27 and 33, as shown in FIG. 5, or whether the dark portion 27 or 33 should be subdivided into smaller portions, as shown in FIG. 7, (step S86). If the dark portion 27 or 33 does not have to be subdivided (No, step S86), then the corrector 9 selects a first correction value that applies a small gain (step S88) and then ends the procedure. If the dark portion 27 or 33 must be subdivided (Yes, step S88), the corrector 9 determines whether or not the display position is either one of the second and fourth dark portions 73 and 85 (step S90).

If the display position lies in the second dark portion 73 or the fourth dark position 85 (Yes, step S90), then the corrector 9 selects a second correction value that applies a great gain (step S92) and then ends the procedure. If the display position is neither one of the dark portions 73 and 85 (No, step S90), then the corrector 9 determines that the display position is either one of the first and third dark portions 71 and 83, selects the first gain (step S88) and then ends the procedure.

If the answer of the step S84 is No, meaning that the display position is neither of the dark portions 27 and 33, the corrector 9 then determines which one of the dark portions 29 and 31 the display position is (step S94). If the display position is neither of the dark portions 29 and 31 (No, step S94), the corrector 9 then determines that the display position is the light portion 35, simply delivers the display data 103 to the LCD panel driver 11 and then ends the procedure. If the display position is the dark portion 29 or 31 (Yes, step S94), the corrector 9 then determines whether or not the dark portion 29 or 31 should be subdivided into smaller portions for correction as in the step S86 (step S96).

If the dark portion 29 or 31 does not have to be subdivided (No, step S96), the corrector 9 selects a third correction value that applies a small gain (step S98) and then ends the procedure. If the dark portion 29 or 31 must be subdivided (Yes, step S96), the corrector 9 determines which one of the sixth and eighth dark portions 77 and 81 the display position is (step S100). If the display position is the sixth dark portion 77 or the eighth dark portion 81 (Yes, step S100), the corrector 9 selects a fourth correction value that applies a great gain (step S102) and then ends the procedure. If the display position is neither of the dark portions 77 and 81 (No, step S100), the corrector 9 determines that the display position is either one of the fifth and seventh dark portions 75 and 79, selects a third correction value that applies a small gain (step S98) and then ends the procedure.

The display data 103 thus corrected by the procedure of FIG. 8 are fed to the LCD panel driver 11. The LCD panel driver 11 displays the input display data 103 on the LCD panel 13. Consequently, the display data are visualized on the LCD panel 13 with substantially the same luminance because their gain has been corrected in accordance with the display position 27, 29, 31 or 33.

The LCD device 1 shown and described is also applicable not only to a mobile of cellular phone or a digital camera including a display unit, such as an LCD panel or similar non-light-emitting type of display panel, but also to any other electronic apparatus including such a display panel, e.g. a computer, a PDA (Personal Digital Assistant) or a music player having such a display unit.

In summary, it will be seen that the present invention provides a luminance control method and a display device capable of displaying data on the display screen of a display panel with luminance accurately controlled as if they were viewed with uniform luminance to thereby reduce irregularities in luminance on the display screen.

The entire disclosure of Japanese patent application No. 2005-254913 filed on Sep. 2, 2005, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A method of establishing uniform luminance on a non-light-emitting display panel when display data are displayed on the non-light-emitting display panel with light being emitted from a light source toward the non-light-emitting display panel via a light guide plate, said method comprising:
a storing step of storing correction values determined beforehand for making the luminance on the display panel substantially uniform; and
a correcting step of reading out one of the correction values corresponding to a position where the display data are displayed for correcting a gain of the display data, thereby making the luminance on the display panel substantially uniform.

2. The method in accordance with claim 1, further comprising a correction value determining step of determining the correction values by measuring the luminance.

3. The method in accordance with claim 1, wherein the light source emits light at least one side of the display panel toward the display panel.

4. The method in accordance with claim 2, wherein the display panel includes a plurality of dark portions and a light portion,
the correction values are determined beforehand such that luminance in the plurality of dark portions becomes substantially equal to luminance in the light portion, and
when the position lies in any one of the plurality of dark portions, said correcting step reads out the correction value corresponding to the position for correcting the gain of the display data.

5. The method in accordance with claim 4, wherein the dark portions are geometrically symmetrical to each other in a plane including the display panel, and
said storing step stores the correction value assigned to one of the dark portions symmetrical to each other.

6. The method in accordance with claim 4, wherein the dark portions and the light portion are divided from each other by boundaries each being approximated by a particular function,
said storing step stores the function and the correction values assigned to the dark portions and designated by the functions, and
said correcting step uses the functions to determine whether or not the position lies in anyone of the dark portions, and reads out, if the position lies in any one of the dark portions, the correction value corresponding to the position for thereby correcting the gain of the display data.

7. The method in accordance with claim 6, wherein at least two of the functions are assigned to each of the boundaries.

8. The method in accordance with claim 6, further comprising a function determining step of measuring irregularities in luminance on the display panel to determine the functions.

9. A display device including a light source for emitting light, a light guide plate for guiding the light and a non-light-emitting display panel illuminated with the light guided by said light guide plate, said display device comprising:
a storage for storing correction values determined beforehand for making the luminance on the display panel substantially uniform; and
a corrector for reading out one of the correction values corresponding to a position where display data are displayed for correcting a gain of the display data to thereby make the luminance on the display panel substantially uniform.

10. The display device in accordance with claim 9, wherein said display panel comprises a liquid crystal display panel.

11. The display device in accordance with claim 9, wherein said storage contains the correction values determined by measuring the luminance.

12. The display device in accordance with claim 9, wherein said light source emits the light onto at least one side of said light guide plate toward said display panel.

13. The display device in accordance with claim 12, wherein said display panel includes a plurality of dark portions and a light portion,
the correction values are determined beforehand such that luminance in the plurality of dark portions becomes substantially equal to luminance in the light portion, and
when the position lies in any one of the plurality of dark portions, said corrector reads out the correction value corresponding to the position from said storage for correcting the gain of the display data.

14. The display device in accordance with claim 12, wherein the dark portions are geometrically symmetrical to each other in a plane including the display panel, and
said storage stores the correction value assigned to one of the dark portions symmetrical to each other.

15. The display device in accordance with claim 13, wherein the dark portions and the light portion are divided from each other by boundaries each being approximated by a particular function,
said storage stores the function and the correction values assigned to the dark portions and defined by the functions, and
said corrector uses the functions to determine whether or not the position detected lies in any one of the dark portions, and reads out, if the position lies in anyone of the dark portions, the correction value corresponding to the position from said storage for thereby correcting the gain of the display data.

16. The display device in accordance with claim 15, wherein at least two of the functions are assigned to each of the boundaries.

17. The display device in accordance with claim 15, wherein said storage stores the functions determined by measuring irregularities in luminance on said display panel.

18. The display device in accordance with claim 9, wherein said device is a display unit of a camera.

19. The display device in accordance with claim 9, wherein said device is a display unit of a cellular phone.
